(19) United States
(12) Patent Application Publication
(10) Pub. No.: US 2014/0089825 A1
(43) Pub. Date: Mar. 27, 2014

(54) APPARATUS AND METHOD FOR WRITING MASH-UP USING MASH-UP BLOCK USER INTERFACE

(71) Applicant: Electronics and Telecommunications Research Institute, (US)

(72) Inventors: Seong Ho LEE, Daejeon (KR); Jae Chul KIM, Daejeon (KR); Young Jae LIM, Daejeon (KR); Yoon Seop CHANG, Daejeon (KR)

(73) Assignee: Electronics and Telecommunications Research Institute, Daejeon (KR)

(21) Appl. No.: 13/772,900

(22) Filed: Feb. 21, 2013

(30) Foreign Application Priority Data
Sep. 27, 2012 (KR) 10-2012-0107546

(51) Int. Cl. G06F 3/048

(52) U.S. Cl. CPC G06F 3/048
USPC 715/762

(57) ABSTRACT

An apparatus and method for writing mash-up using a mash-up block user interface are disclosed. According to an aspect, a mash-up writing apparatus for writing mash-up using a plurality of blocks includes: a block writing unit configured to create input and output block keys corresponding to each block based on input and output parameters corresponding to the block; and a workflow writing unit configured to create a block user interface (UI) for the block as an image by analyzing the input and output block keys and representing individual data types configuring the input and output block keys as images of different shapes. Accordingly, a user may intuitively write mash-up.

### CLAIM FOR PRIORITY

This application claims priority to Korean Patent Application No. 10-2012-0107546 filed on Sep. 27, 2012 in the Korean Intellectual Property Office (KIPO), the entire contents of which are hereby incorporated by reference.

### BACKGROUND

1. Technical Field

Example embodiments of the present invention relate in general to an apparatus for writing mash-up, and more specifically, to an apparatus and method for writing mash-up using a mash-up block user interface (UI).

2. Related Art

In general, mash-up means combining or blending various kinds of content or services to create new contents or services. Here, the various kinds of contents or services may be configured with program modules called blocks. Mash-up represents a web-based data-integrated application, and can be created with a mash-up writing tool for connecting or combining blocks. As an example of mash-up, there is an application in which Daum's map service is combined with Naver's picture service. In the mash-up, if a user clicks a specific location on a map with a mouse, pictures related to the specific location are displayed on the map.

In a general process for writing mash-up, a mash-up developer designs the kind of mash-up that he or she will produce, and searches for and selects open application program interfaces (APIs) that will be used for producing the designed mash-up. In the above example, a mash-up developer analyzes Daum's open map APIs and Naver's open APIs to recognize the characteristics of the individual open API services, that is, blocks. Here, the characteristics of the blocks may be communication protocols (codes), data formats, the formats of input and output data, etc.

That is, an apparatus for writing mash-up provides a function of disposing or arranging open APIs, that is, blocks (widgets, components, etc.), and connecting the inputs and outputs of the individual blocks using the data formats of the inputs and outputs of the blocks. Also, the apparatus for writing mash-up provides a function of specifying scripts or codes.

However, since functions that are provided by a general apparatus for writing mash-up require a large amount of resources for analysis on the inputs and outputs of blocks, there are difficulties in implementing such functions in a mobile device environment with limited resources.

Also, general users having no concept of programming have difficulty writing mash-up since they cannot easily find blocks whose input and output data formats match or can be connected to each other.

That is, it is difficult to implement a general apparatus for writing mash-up in an environment with limited resources, and also for general users to intuitively know codes such as data input and output formats of blocks, which is a limitation for general users to conveniently use such a general apparatus for writing mash-up.

### SUMMARY

Accordingly, example embodiments of the present invention are provided to substantially obviate one or more problems due to limitations and disadvantages of the related art.

An example embodiment of the present invention provides a mash-up writing apparatus which allows a user to easily write mash-up, by providing a visualized block user interface (UI) based on input and output information of open application program interfaces (APIs) when the user produces new mash-up so that the user can intuitively know a connection relationship between the open APIs.

An example embodiment of the present invention also provides a mash-up writing method which allows a user to conveniently write mash-up in a mobile environment with limited resources using a visualized block UI.

In an example embodiment, a mash-up writing apparatus for writing mash-up using a plurality of blocks includes: a block writing unit configured to create input and output block keys corresponding to each block based on input and output parameters corresponding to the block; and a workflow writing unit configured to create a block user interface (UI) for the block as an image by analyzing the input and output block keys and representing individual data types configuring the input and output block keys as images of different shapes.

The input and output block keys may include first information indicating the numbers of the input and output parameters, and second information sequentially indicating data types of the input and output parameters, respectively.

The block UI may be created by sequentially representing the input block key as a figure whose upper base has an inwardly protruding shape corresponding to a data type, and sequentially representing the output block key as a figure whose lower base has an outwardly protruding shape corresponding to the data type.

The shape of the input block key may correspond to the shape of the output block key.

The workflow writing unit may include a block category unit configured to receive the input and output block keys and a block category including the plurality of blocks from the block writing unit, and to maintain the input and output block keys and the block category.

The workflow writing unit may include a block recommending unit configured to analyze input and output parameters of a first block selected from the block category to search for a second block that is able to be combined with the first block, and to recommend the second block.

The workflow writing unit may include a block adjusting unit configured to convert, when the first block is combined with the second block, a data type of one of the first and second blocks if the first and second blocks have different data types although the first and second blocks have the same numbers and name meanings of input and output parameters.

The block writing unit may include: a block defining unit configured to create block-defined data corresponding to the block based on the characteristics of the block; and a block resource manager configured to search for the block-defined data and the input and output block keys, and to provide the block-defined data and the input and output block keys to the workflow writing unit.

The block may be defined by configuring an open application program interface (open API) as a program module.

In another example embodiment, a mash-up writing method of a mash-up writing apparatus which creates mash-up using a plurality of blocks includes: creating input and output block keys corresponding to each block based on input and output parameters corresponding to the block; selecting a first block from a block category including the plurality of blocks; and creating a block user interface (UI) for the first block as an image by analyzing input and output block keys of the first block and representing individual data types configuring the input and output block keys as images of different shapes.

The input and output block keys may include first information indicating the numbers of the input and output parameters, and second information sequentially indicating data types of the input and output parameters, respectively.

The block UI may be created by sequentially representing the input block key as a figure whose upper base has an inwardly protruding shape corresponding to a data type, and sequentially representing the output block key as a figure whose lower base has an outwardly protruding shape corresponding to the data type.

The shape of the input block key may correspond to the shape of the output block key.

The mash-up writing method may further include analyzing the input and output parameters of the first block to search for a second block that is able to be combined with the first block, and recommending the second block.

The mash-up writing method may further include converting, when the first block is combined with the second block, a data type of one of the first and second blocks if the first and second blocks have different data types although the first and second blocks have the same numbers and name meanings of input and output parameters.

The block may be defined by configuring an open application program interface (open API) as a program module.

The mash-up writing apparatus according to the present embodiment as described above allows a user to conveniently write mash-up, by providing block UIs with images of different shapes based on input and output information about blocks so that the user can easily know a connection relationship between the blocks.

Also, the mash-up writing method according to the present embodiment as described above allows a user having little programming knowledge to easily write an application in a mobile device environment with limited resources.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view schematically showing an apparatus for writing mash-up using a mash-up block user interface (UI) according to an embodiment of the present invention;

FIG. 2 shows basic structures of block keys according to an embodiment of the present invention;

FIG. 3 shows examples of input and output block keys according to an embodiment of the present invention;

FIG. 4 shows an example of a block UI table for representing data types configuring block keys of blocks as images of different shapes;

FIG. 5 shows a block UI of a block A, created using block keys and block-defined data of the block A based on the block UI table of FIG. 4;

FIG. 6 schematically shows an example of a graphic interface (GI) that is provided by a workflow controller according to an embodiment of the present invention; and

FIG. 7 is a flowchart showing a mash-up writing method according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the appended drawings.

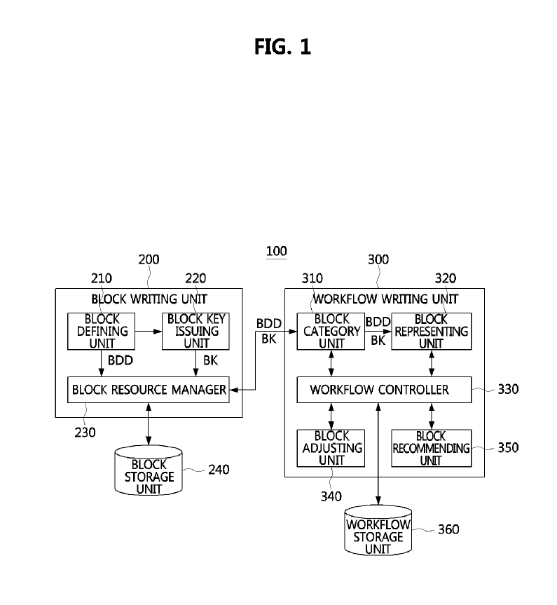

FIG. 1 is a conceptual view schematically showing an apparatus 100 for writing mash-up using a mash-up block user interface (UI) according to an embodiment of the present invention. Hereinafter, for convenience of description, the apparatus 100 for writing mash-up using a UI of a mash-up block is referred to as a mash-up writing apparatus.

First, as shown in FIG. 1, the mash-up writing apparatus 100 may include a block writing unit 200 and a workflow writing unit 300. Also, the mash-up writing apparatus 100 may further include a block storage unit 240 and a workflow storage unit 360.

Here, the block writing unit 200 may include a block defining unit 210, a block key issuing unit 220, and a block resource manager 230.

The block defining unit 210 recognizes the characteristics of the individual blocks of a plurality of open application program interfaces (open APIs), and creates a plurality of pieces of block-defined data (BDD) corresponding to the characteristics of the respective blocks.

Also, the block defining unit 210 provides the plurality of pieces of BDD to the block key issuing unit 220 and the block resource manager 230.

Here, the block means a program module configured with various contents or services released on the web by a web service provider. For example, Google's map service, Craigslist's real-estate information service, and Flickr's picture service are configured as program modules and may be blocks. That is, a block means a module that performs a general function or a unit function that is provided as an open API.

Meanwhile, the BDD may include a communication protocol, metadata of the corresponding block, HyperText Markup Language (HTML) appearing on a web page, etc.

Here, the communication protocol is used for data transmission/reception to/from an open API service provider, and for example, the communication protocol includes JavaScript, REST, SOAP, etc. That is, the communication protocol means codes for performing a unit function.

Generally, metadata is secondary information that describes data types in order to intelligently control information and provide structural access to the information. That is, the data type of a characteristic representing a block is metadata, which can be defined as data defining the type of data, or “data about data.”

The metadata of a block is information that is used to search for various kinds of information about the block, and includes input and output information of the block, that is, a data format. The data format includes, for example, XML, JSON, PHP, etc.

Meanwhile, for convenience of description, FIG. 1 shows an example in which BDD is provided to the block resource manager 230, however, the block defining unit 210 may provide block metadata among BDD to the block key issuing unit 220.

The block key issuing unit 220 creates a plurality of block keys BK corresponding to metadata of individual blocks, using input and output information (that is, metadata) included in the individual blocks, and provides the plurality of block keys BK to the block resource manager 230.

Hereinafter, block keys BK according to an embodiment of the present invention will be described in more detail with reference to FIG. 2.

FIG. 2 shows the basic structures of the block keys BK.

First, as shown in FIG. 2, the block keys BK may be configured with an input block key IBK and an output block key OBK, wherein the input block key IBK is created based on input metadata corresponding to input information among the metadata of the corresponding block, and the output block key OBK is created based on output metadata corresponding to output information among the metadata of the block.

Each of the input and output block keys IBK and OBK may include first information 21 indicating the number of the corresponding input/output parameters, and second information 22 sequentially indicating the data types of the input/output parameters.

In detail, for example, if the number of input parameters is N, the first information 21 of the input block key IBK is N. The data type identifiers (IDs) of the input parameters are sequentially represented after the number N of the input parameters. Accordingly, the second information 22 of the input block key IBK may include data type IDs of the N parameters. In detail, for example, an input parameter #01 represents the data type ID of a parameter (referred to as a first input parameter) that is firstly input. If the data type ID of the first input parameter is an integer, the input parameter #01 may be a numeral between 0 and 99. An input parameter #02 represents the data type ID of a parameter that is secondly input, and an input parameter #N represents the data type ID of a parameter that is input finally, that is, in the n^{th} order.

Likewise, if the number of output parameters is M, the first information 21 of the output block key OBK is M. The data type IDs of the output parameters are sequentially represented after the number M of output parameters. Accordingly, the second information 21 of the output block key OBK may include data type IDs of the M parameters. In detail, for example, an output parameter #01 represents the data type ID of a parameter (referred to as a first output parameter) that is firstly output. If the data type ID of the first output parameter is an integer, the output parameter #01 may be a numeral between 0 and 99. An output parameter #02 represents the data type ID of a parameter that is secondly output, and an output parameter #M represents the data type ID of a parameter that is output finally, that is, in the m^{th} order.

That is, the input block key IBK and the output block key OBK may be represented as follows.

Input Block Key (IBK): (Number of Input Parameters)+{(Data Type IDs of Input Parameters)}*

Output Block Key (OBK): (Number of Output Parameters)+{(Data Type IDs of Output Parameters)}*

Here, * means repetition by the number of input/output parameters.

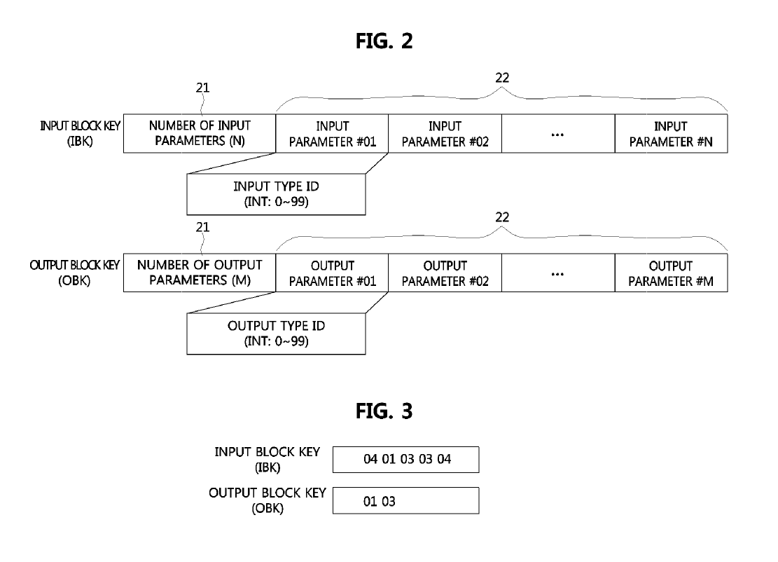

The input and output blocks IBK and OBK will be described in more detail with reference to FIG. 3 below.

FIG. 3 shows examples of input and output block keys (IBK and OBK of FIG. 2) according to an embodiment of the present invention;

First, for convenience of description, a block A is assumed.

Input metadata of the block A has four input parameters. The respective input parameters are defined as follows.
Building name (type: string(01))
Latitude (type: float(03))
Longitude (type: float(03))
Time (type: dateTime(04))

The output metadata of the block A has an output parameter. Also, the output parameter is defined as follows.
Distance value (type: float(03))

If the block A is defined as mentioned above, its input and output block keys IBK and OBK may be represented as in FIG. 3.

The first element [04] among [04 01 03 03 04] of the input block key IBK represents “4” which is the number of input parameters, the second element [01] represents (01) of string(01) which is the data type of building name, the third element [03] represents (03) of float(03) which is the data type of latitude, the fourth element [03] represents (03) of float(03) which is the data type of longitude, and the fifth element [04] represents (04) of dateTime(04) which is the data type of time.

The first element [01] among [01 03] of the output block key OBK represents “1” which is the number of output parameters, and the second element [03] represents (03) of float(03) which is the data type of distance value.

However, the configuration as described above is only exemplary, and block keys corresponding to input and output metadata may be created by various other methods.

Referring again to FIG. 1, the block resource manager 230 will be described below.

The block resource manager 230 stores a plurality of pieces of BDD respectively corresponding to a plurality of blocks, created by the block defining unit 210, and a plurality of block keys BKs respectively corresponding to the plurality of blocks, issued by the block key issuing unit 220, in the block storage unit 240.

Also, the block resource manager 230 searches for the plurality of pieces of BDD and the plurality of block keys BKs in the block storage unit 240 according to a request from the workflow writing unit 300, and provides the found BDD and BKs to the workflow writing unit 300.

Also, although not shown in FIG. 1, the block resource manager 230 may store a block category in the block storage unit 240, search for the block category in the block storage unit 240, and provide the found block category to the workflow writing unit 300. The block storage unit 240 stores the plurality of pieces of BDD and the plurality of block keys BKs, and if the block resource manager 230 requests the block storage unit 240 to send the BDD and block keys BKs, provides information corresponding to the requested information to the block resource manager 230.

Also, although not shown in FIG. 1, the block storage unit 240 may store a block category, and if the block resource manager 230 requests the block storage unit 240 to send the block category, provide the block category to the block resource manager 230.

The workflow writing unit 300 may include a block category unit 310, a block representing unit 320, a workflow controller 330, a block adjusting unit 340, and a block recommending unit 350.

First, the block category unit 310 requests the block resource manager 230 to send a plurality of pieces of BDD and a plurality of block keys BKs, and maintains the plurality of pieces of BDD and the plurality of block keys BKs transmitted from the block resource manager 230.

Meanwhile, although not shown in FIG. 1, the block category unit 310 may request the block resource manager 230 to send a block category about a plurality of blocks, and maintain the block category transmitted from the block resource manager 230.

Also, the block category unit 310 provides the block category to the workflow controller 330.

The block representing unit 320 analyzes the BDD and BKs stored in the block category unit 310, and represents block UIs corresponding to the BKs, that is, block images on a graphic interface (GI) screen.

For this, the block representing unit 320 may receive the BDD and BKs from the block category unit 310.

In detail, the block representing unit 320 analyzes an input block key (IBK of FIG. 3) and an output block key (OBK of FIG. 3) of each of a plurality of blocks, and represents each of data types configuring the input and output block keys IBK and OBK, as a predetermined shape of image.

In more detail, for example, the input and output block keys IBK and OBK may be represented as 2-dimensional figures. For example, an input block key IBK may be represented in the shape of a 2-dimensional figure whose upper base has an inwardly protruding part, and an output block key OBK may be expressed in the shape of a 2-dimensional figure whose lower base has an outwardly protruding part, or vice versa.

Block UIs (that is, block images) of input and output block keys IBK and OBK for the same data type may correspond to each other. In more detail, for example, if a block UI of an input block key IBK for a data type has a concave quadrangle part, a block UI of an output block key OBK for the same data type may have a convex quadrangle part.

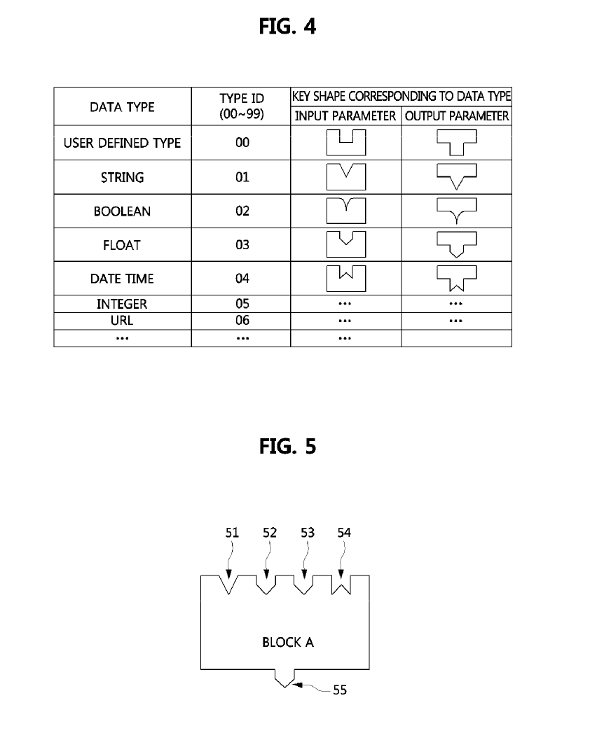

Hereinafter, block images (that is, block UIs) corresponding to block keys (BK of FIG. 1) of blocks according to an embodiment of the present invention will be described in more detail with reference to FIG. 4.

FIG. 4 shows an example of a block UI table for representing data types configuring block keys BKs of blocks as images of different shapes.

In FIG. 4, data type is a data type for each of input and output parameters, and type ID is a data ID for each of the input and output parameters.

If the type ID of user defined type is 00, its input parameter may be represented as a 2-dimensional square whose upper base has an inwardly protruding quadrangle shape, and its output parameter may be represented as a 2-dimensional square whose lower base has an outwardly protruding quadrangle shape.

If the type ID of String is 01 (that is, string(01)), its input parameter may be represented as a 2-dimensional square whose upper base has an inwardly protruding triangle shape, and its output parameter may be represented as a 2-dimensional square whose lower base has an outwardly protruding triangle part.

If the type ID of Boolean is 02 (that is, Boolean(02)), its input parameter may be represented as a 2-dimensional square whose upper base has an inwardly protruding triangle shape, the upper corners of which are rounded, and its output parameter may be represented as a 2-dimensional square whose lower base has an outwardly protruding triangle shape, the upper corners of which are rounded.

If the type ID of Float is 03 (that is, float(03)), its input parameter may be represented as a 2-dimensional square whose upper base has an inwardly protruding pentagon shape positioned upside down, and its output parameter may be represented as a 2-dimensional square whose lower base has an outwardly protruding pentagon shape positioned upside down.

If the type ID of dateTime is 04 (that is, dateTime(04)), its input parameter may be represented as a 2-dimensional square whose upper base has an inwardly protruding tongs shape, and its output parameter may be represented as a 2-dimensional square whose lower base has an outwardly protruding tongs shape.

Likewise, although not shown in FIG. 4, integer(05), URL(06), etc. can also be represented as images of different shapes.

The above-described embodiment shows examples of block Uls, and the blocks may be represented as images of various other shapes. Also, the above-described embodiment relates to the case in which a shape corresponding to a data type is based on a 2-dimensional rectangle, however, a shape corresponding to a data type may be based on other 2-dimensional or 3-dimensional figures.

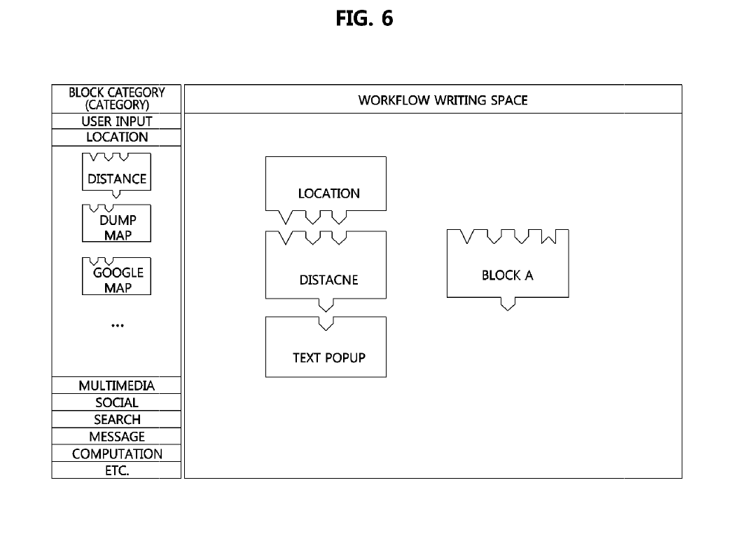

Hereinafter, an example of a block UI will be described in more detail with reference to FIG. 5.

FIG. 5 shows a block UI of a block A, created using block keys and block-defined data of the block A based on the block UI table of FIG. 4.

As shown in FIG. 5, since the block A has four input parameters, four FIGS. 51 through 54 protruding inwardly are created in the upper base of a 2-dimensional rectangle. Also, since the block A has an output parameter, a FIG. 55 protruding outwardly is created in the lower base of the 2-dimensional rectangle.

With regard to the four figures respectively corresponding to the four input parameters of the block A and located in the upper base of the 2-dimensional rectangle, the first input parameter of the block A, which is string(01) of building name, is represented as an inwardly protruding triangle shape 51, corresponding to string(01), in the upper base of the 2-dimensional rectangle. The second and third input parameters of the block A, which are float(03) of latitude and longitude, are represented as inwardly protruding pentagon shapes 52 and 53 positioned upside down, corresponding to float(03), in the upper base of the 2-dimensional rectangle. Also, the final input parameter of the block, which is dateTime(04) of time, is represented as an inwardly protruding tongs shape 54 corresponding to dateTime(04), in the upper base of the 2-dimensional rectangle.

Also, the output parameter of the block A, which is float(03) of distance value, is represented as an outwardly protruding pentagon shape 55 positioned upside down, corresponding to float(03), in the lower base of the 2-dimensional rectangle.

That is, the block A is represented as a structure in which four shapes respectively corresponding to four input parameters are arranged to protrude inwardly in the upper base of a base figure, and a shape corresponding to an output parameter is positioned to protrude outwardly in the lower base of the base figure.

Referring again to FIG. 1, as described above, the block representing unit 320 extracts shapes corresponding to the input and output parameters of a block using the BDD and BKs of the block, and combines the extracted shapes.

At this time, the block representing unit 320 may create a block UI of a block selected by a user, for example, from a block category. In detail, for example, if a user selects a block from a block category provided by the GI of the workflow controller 330, the block representing unit 320 analyzes the input and output parameters of the selected block, and represents the block as an image of a shape corresponding to the block, thereby creating a block UI.

As such, since the block representing unit 320 creates a block UI for a block, the user may intuitively recognize blocks that can be combined with each other.

The workflow controller 330 provides a GI for allowing a user to select blocks from a block category or for providing block UIs for blocks selected by the user so as to allow the user to connect, combine, and move the block UIs.

Also, the workflow controller 330 stores workflow metadata created by combining and connecting block UIs in the workflow storage unit 360, and searches for workflow metadata stored in the workflow storage unit 360. Here, a workflow means being created by combining and connecting block UIs.

Also, the workflow controller 330 integrates BDD of a plurality of blocks included in a written workflow so that the workflow can be served as an application.

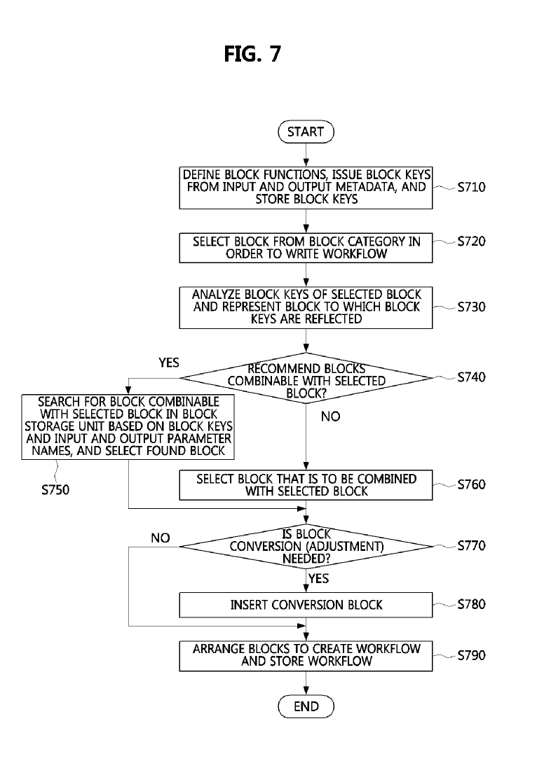

Hereinafter, a GI that is provided by the workflow controller 330 will be described with reference to FIG. 6.

FIG. 6 schematically shows an example of a GI that is provided by the workflow controller 330, according to an embodiment of the present invention.

As shown in FIG. 6, a block category is provided in the left part of the GI. The block category may be received, for example, from the block category unit (310 of FIG. 1).

The GI may provide block UIs with block shapes selected by a user. The block UIs may be, as described above, created by the block representing unit (320 of FIG. 1), and the block UIs created by the block representing unit are provided for the user through a GI.

In detail, for example, the block category includes User Input for receiving a user's input, Location for representing a location, a place, etc., MultiMedia for providing video or music, Social for providing social network services (SNSs), Search for providing a search function, Message for sending messages, Computation for providing a computation function or the like, etc. As seen in the Location of FIG. 6, Distance representing a distance, Daum Map representing Daum's map service, Google Map representing Google's map service, etc. are represented as block UIs.

In the right part of the GI, block UIs for blocks selected by the user are displayed to provide a workflow writing space which is a space for allowing the user to create a workflow by moving, connecting, and combining the block UIs.

The user selects blocks that are to be used in the workflow writing space from the block category, and moves and connects block UIs for the selected blocks in the workflow writing space, thereby writing a workflow.

FIG. 6 shows an example in which Location, Distance, Text PopUP (a block UI for popping up text), and a block A are selected, and block UIs respectively corresponding to the Location, the Distance, the Text PopUP (a block UI for popping up text), and the block A are arranged in a workflow writing space.

As such, by using images of block UIs and a GI for allowing a user to intuitively recognize the images of block UIs, the user can easily write a workflow.

Referring again to FIG. 1, the block adjusting unit 340 provides a function of converting data types of two blocks (that is, block UIs) that a user wants to combine with each other if the blocks have different data types even though they have the same numbers and name meanings of input and output parameters.

In detail, the block adjusting unit 340, which is a built-in component, provides a function of automatically inserting a conversion block to adjust a block so that no programming error occurs.

The block recommending unit 350 searches for blocks that can be combined with a selected block based on the input and output data (for example, BKs and metadata) of the selected block.

A method in which the block recommending unit 350 searches for blocks that can be combined with a selected block is to search for blocks matching the selected block in the block storage unit 240, based on the numbers, data types, and name meanings of input and output parameters of the selected block. The blocks recommended by the block recommending unit 350 may be provided as block UIs so that a user can select one or more of the block UIs, and also the ranks or use frequencies of the recommended blocks may be provided.

The workflow storage unit 360 stores data provided by the workflow controller 330, and provides data requested from the workflow storage unit 360 to the workflow controller 330.

Meanwhile, as described above, the block storage unit 240 and the workflow storage unit 360 each store data corresponding to blocks and workflows, and may be configured as a general database management system.

Hereinafter, a mash-up writing method according to an embodiment of the present invention will be described with reference to FIG. 7.

FIG. 7 is a flowchart showing the mash-up writing method according to the embodiment of the present invention.

First, as shown in FIG. 7, a plurality of blocks are defined, and block keys are issued and stored based on input and output metadata of the plurality of blocks (S710).

A user selects a block from a block category in order to write a workflow (S720).

Then, a block UI in which the block keys of the block are reflected to represent the block is created based on at least one of the block keys and metadata of the block (S730).

Then, it is determined whether to recommend blocks that can be combined with the selected block (S740).

If the user uses no block recommendation function, a new block that is to be combined with the selected block is selected (S760). On the other hand, if the user uses a block recommendation function, blocks are searched for based on BKs and input and output parameter names, and blocks that can be combined with the selected block are selected (S750). At this time, operation of searching for blocks with reference to BKs may be, as described above, performed by the block storage unit (240 of FIG. 1).

Next, it is determined whether block conversion or adjustment is needed for connection and combination between selected blocks or between the selected block and the recommended block (S770).

If it is determined that block conversion is needed, a conversion block is inserted instead of a block that should be adjusted (S780). If no block conversion is needed or if a conversion block has been already inserted, the resultant blocks are arranged to create a workflow, and the workflow is stored (S790).

As described above, according to the mash-up writing apparatus and method, input and output block keys for blocks are created, and the blocks are represented as images of different shapes based on the block keys. Therefore, a user can easily recognize a connection relationship between blocks so as to easily write mash-up.

Also, a general user having little programming knowledge can easily write an application in a mobile device environment with limited resources.

In the embodiments described above, the individual components are shown as separate units, however, the components may be integrated into one unit. For example, all the components may be included in a controller or a processor to perform a series of operations.

While the example embodiments of the present invention and their advantages have been described in detail, it should be understood that various changes, substitutions and alterations may be made herein without departing from the scope of the invention.

What is claimed is:

1. A mash-up writing apparatus for writing mash-up using a plurality of blocks, comprising:
a block writing unit configured to create input and output block keys corresponding to each block based on input and output parameters corresponding to the block; and
a workflow writing unit configured to create a block user interface (UI) for the block as an image by analyzing the input and output block keys and representing individual data types configuring the input and output block keys as images of different shapes.

2. The mash-up writing apparatus of claim 1, wherein the input and output block keys include first information indicating the numbers of the input and output parameters, and second information sequentially indicating data types of the input and output parameters, respectively.

3. The mash-up writing apparatus of claim 1, wherein the block UI is created by sequentially representing the input block key as a figure whose upper base has an inwardly protruding shape corresponding to a data type, and sequentially representing the output block key as a figure whose lower base has an outwardly protruding shape corresponding to the data type.

4. The mash-up writing apparatus of claim 3, wherein the shape of the input block key corresponds to the shape of the output block key.

5. The mash-up writing apparatus of claim 1, wherein the workflow writing unit comprises a block category unit configured to receive the input and output block keys and a block category including the plurality of blocks from the block writing unit, and to maintain the input and output block keys and the block category.

6. The mash-up writing apparatus of claim 5, wherein the workflow writing unit comprises a block recommending unit configured to analyze input and output parameters of a first block selected from the block category to search for a second block that is able to be combined with the first block, and to recommend the second block.

7. The mash-up writing apparatus of claim 6, wherein the workflow writing unit comprises a block adjusting unit configured to convert, when the first block is combined with the second block, a data type of one of the first and second blocks if the first and second blocks have different data types even though the first and second blocks have the same numbers and name meanings of input and output parameters.

8. The mash-up writing apparatus of claim 1, wherein the block writing unit comprises:
a block defining unit configured to create block-defined data corresponding to the block based on the characteristics of the block; and
a block resource manager configured to search for the block-defined data and the input and output block keys, and to provide the block-defined data and the input and output block keys to the workflow writing unit.

9. The mash-up writing apparatus of claim 1, wherein the block is defined by configuring an open application program interface (open API) as a program module.

10. A mash-up writing method of a mash-up writing apparatus which creates mash-up using a plurality of blocks, comprising:
creating input and output block keys corresponding to each block based on input and output parameters corresponding to the block;
selecting a first block from a block category including the plurality of blocks; and
creating a block user interface (UI) for the first block as an image by analyzing input and output block keys of the first block and representing individual data types configuring the input and output block keys as images of different shapes.

11. The mash-up writing method of claim 10, wherein the input and output block keys include first information indicating the numbers of the input and output parameters, and second information sequentially indicating data types of the input and output parameters, respectively.

12. The mash-up writing method of claim 10, wherein the block UI is created by sequentially representing the input block key as a whose upper base has an inwardly protruding shape corresponding to a data type, and sequentially representing the output block key as a figure whose lower base has an outwardly protruding shape corresponding to the data type.

13. The mash-up writing method of claim 12, wherein the shape of the input block key corresponds to the shape of the output block key.

14. The mash-up writing method of claim 10, further comprising analyzing the input and output parameters of the first block to search for a second block that is able to be combined with the first block, and recommending the second block.

15. The mash-up writing method of claim 14, further comprising converting, when the first block is combined with the second block, a data type of one of the first and second blocks if the first and second blocks have different data types even though the first and second blocks have the same numbers and name meanings of input and output parameters.

16. The mash-up writing method of claim 10, wherein the block is defined by configuring an open application program interface (open API) as a program module.
